(19) United States
(12) Patent Application Publication
(10) Pub. No.: US 2005/0145554 A1
(43) Pub. Date: Jul. 7, 2005

(54) Multiple flow sink counter-top water sprayer and filter system

(76) Inventors: William G. Cunningham, Clearwater, FL (US); David Swain, Palm Harbor, FL (US); George Lutich, Palm Harbor, FL (US)

Correspondence Address: MELVIN K. SILVERMAN, 500 WEST CYPRESS CREEK ROAD, SUITE 500, FT. LAUDERDALE, FL, 33309, US

(21) Appl. No.: 11/061,486

(22) Filed: Feb. 17, 2005

Related U.S. Application Data
(63) Continuation-in-part of application No. 11/013,919, filed on Dec. 16, 2004.
Application No. 11/013,919 is a continuation-in-part of application No. 09/781,865, filed on Feb. 12, 2001, now abandoned.
Application No. 09/781,865 is a continuation-in-part of application No. 09/736,637, filed on Dec. 14, 2000, now Pat. No. 6,599,428.
Application No. 09/736,637 is a continuation-in-part of application No. 09/431,942, filed on Oct. 1, 1999, now abandoned.

(51) Int. Cl. B01D 27/02

(52) U.S. Cl. 210/282

(57) ABSTRACT

A multiple flow sink counter-top water sprayer and filter system includes a selectably by-passable filter cartridge. The system includes a housing having an upstream portion and a downstream portion, defining, through these portions, channels for the flow of water. An inlet to the upstream portion permits flow of water into the channels, and respective outlets in the downstream portion of the housing discharges respective flows of water from the channels. Also provided is an annular water-purifying cartridge having a tubular shell including concentric interior and exterior walls to contain a filter material, the cartridge including an axial bore running lengthwise of the cartridge and the exterior wall of the cartridge secured within the upstream portion at a radial offset from an interior surface of the upstream portion of the housing to establish an annular path of flow which by-passes the cartridge. The system selectably blocks an outlet of the annular path of flow about the cartridge, where water within the path is confined in forcing it through the cartridge, into the axial bore, and through an outlet of the bore into the downstream portion of the housing, and in turn to a stream spout outlet of filtered water of the sprayer.

### CROSS REFERENCE TO RELATED APPLICATION

This application is a continuation-in-part application of co-pending patent application Ser. No. 11/013,919; filed Dec. 16, 2004, which is a continuation-in-part of patent application Ser. No. 09/781,865, filed Feb. 12, 2001, now abandoned, which is also a continuation-in-part application of patent application Ser. No. 09/736,637, filed Dec. 14, 2000, now U.S. Pat. No. 6,599,428, which is a continuation-in-part application of Ser. No. 09/431,942, filed Oct. 1, 1999, now abandoned. All prior patent applications are herein incorporated by reference in their entirety.

### FIELD OF THE INVENTION

The present invention relates to fluid treatment. In particular, the present invention relates to water filtration devices for counter-top sink spray attachments.

### BACKGROUND OF THE INVENTION

Tap water contains many contaminants. If not removed from the water, these contaminants may present health risks, may damage plumbing and personal property, and may adversely affect the taste of water. The principal contaminants naturally occurring in water are iron, sulfur, manganese, lead, and cryptosporidium cysts. Many man-made contaminants are also now found in tap water. These contaminants may be introduced into the water supply as part or as by-products of herbicides, pesticides, fertilizers and the like placed on and into the ground. These contaminants are believed to be carcinogenic and may present serious long term health risks to users of this contaminated water.

Traditionally, water filters have been placed under the main faucet spout, thereby filtering the water after it has traveled through the main faucet. Water filters of the prior art have been attached to sink faucets by various mechanisms. Typically, filters are mounted onto the threads of a faucet diverter section or have hoses attached thereto. The filter cartridge protrudes sideways or upwards from the diverter section into the upper work area of the sink or are placed behind the faucet. The placement of the filter in these positions is cumbersome for a user cleaning dishes or performing routine hygienic functions. Further, the placement of the filter outward and upward from the faucet is in plain view and unsightly to the user. Providing filtered water outside of the sink area is also difficult to accomplish with filters that are placed on the main faucet. Therefore, a concealed or partially concealed water filter for a spray attachment is desirable to provide filtered water outside of the sink area.

Prior art related to the instant invention include U.S. Pat. No. 4,107,046 (1978) to Corder; U.S. Pat. No. 5,823,229 (1998) to Betrand, and U.S. Pat. No. 6,093,313 (2000) to Bovaird. None of these or other art known to Applicants, use or can accommodate a so-called annular or block filter, such as a carbon block filter solder under the mark CLEAR TAP™ by American Standard. Prior to the annular carbon filter, products such as that reflected in Corder, could not provide sufficient flow rate of filtered water thru the device. The carbon block filter is a more effective filtration medium than was various granules used in the prior art. In combination, the instant invention can enable flow rates of over 1900 cc/minute, which cannot be achieved in the prior art. Heretofore, the block filter had not been adapted to use in a sink hand-held sprayer for use with a countertop. The instant system also employs a novel method of securing the filter in annular relation to the wall of the filter housing.

### SUMMARY OF THE INVENTION

The invention is a multiple flow sink counter-top water sprayer and filter system having a selectably by-passable filter cartridge. It includes a housing having an upstream portion and a downstream portion and defining, through said portions, channels for the flow of water. An inlet in said upstream portion for admitting a flow of water into said channels, and respective outlets in said downstream portion of said housing discharge respective flows of water from said channels. Also provided is an annular water-purifying cartridge having a tubular shell including concentric interior and exterior walls to contain a filter material, said cartridge including an axial bore running lengthwise of said cartridge and said exterior wall of said cartridge secured within said upstream portion at a radial offset from an interior surface of said upstream portion establish an annular path of flow which by-passes said cartridge. The system further includes means for selectably blocking an outlet of said annular path of flow about said cartridge, wherein water within said path is confined therein forcing said path of water radially through said cartridge, into said axial bore thereof, and therefrom through an outlet of said bore into said downstream portion of said housing, and in turn to a stream spout outlet of filtered water of said sprayer. Further included are means for selectably blocking said axial bore of said cartridge, thereby forcing said flow of water into said annular path of flow external to said cartridge and into fluid communication with a circumferential input to said downstream portion of said housing and to a spray spout outlet of unfiltered water of said sprayer.

It is an object of the invention to provide a sink counter-top sprayer and filter system having selectable filtered and non-filtered outputs.

It is a further object to provide a sprayer of the above type capable of furnishing a filtered water output in excess of 1700 cc/minute.

It is another object to provide a sink top sprayer particularly adapted for use with an annular block carbon filter.

The above and yet other objects and advantages of the present invention will become apparent from the hereinafter set forth Brief Description of the Drawings, Detailed Description of the Invention and claims appended herewith.

### BRIEF DESCRIPTION OF THE DRAWINGS

FIG. 1 is a longitudinal perspective view of the inventive hand-held kitchen sink-top water sprayer and filter showing the geometry of the stream and spray outlets thereof.

FIG. 2 is a longitudinal schematic view showing the basic path of flow of filtered water when the filter button F is depressed.

FIG. 3 is a longitudinal schematic view of the inventive system showing the basic path of flow of water when a non-filtered spray is desired, said figure depression of the spray buttons of the head.

FIG. 4 is a breakaway cross-sectional view taken along Line 4-4 of FIG. 2, showing therein the internal paths of flow for the filtered stream and unfiltered spray functions.

FIG. 5 is a longitudinal cross-sectional view taken along Line 5-5 of FIG. 4 showing the path of flow of filtered water through the instant system.

FIG. 6 is a radial cross-sectional view taken along Line 6-6 of FIG. 5.

FIG. 7 is a perspective view of a representative solid carbon filter of a type usable with the present invention.

FIG. 8 is a cross-section view taken through Line 8-8 of FIG. 5, and showing the sprayhead assembly with its filter button F and toggle switch in filter flow mode.

FIG. 9 is cross-sectional partial breakaway view taken through Line 9-9 of FIG. 8.

FIG. 10 is an enlarged view of the upper portion of FIG. 9.

FIG. 11 is a partial breakaway view of the head of the spray assembly taken along Line 11-11 of FIG. 9.

FIG. 12 is a partial breakaway view of the spray head of the system taken through Line 12-12 of FIG. 9.

FIG. 13 is a longitudinal cross-sectional view, similar to that of FIG. 5, however showing the path of fluid flow in the unfiltered mode of operation.

FIG. 14 is a cross-sectional view of the dispensing head of the present system taken through Line 14-14 of FIG. 13, showing the spray buttons and toggle switch in spray mode.

FIG. 15 is a cross-sectional schematic breakaway view taken along Line 15-15 of FIG. 14 showing the operation thereof during unfiltered spray mode of operation.

### DETAILED DESCRIPTION OF THE INVENTION

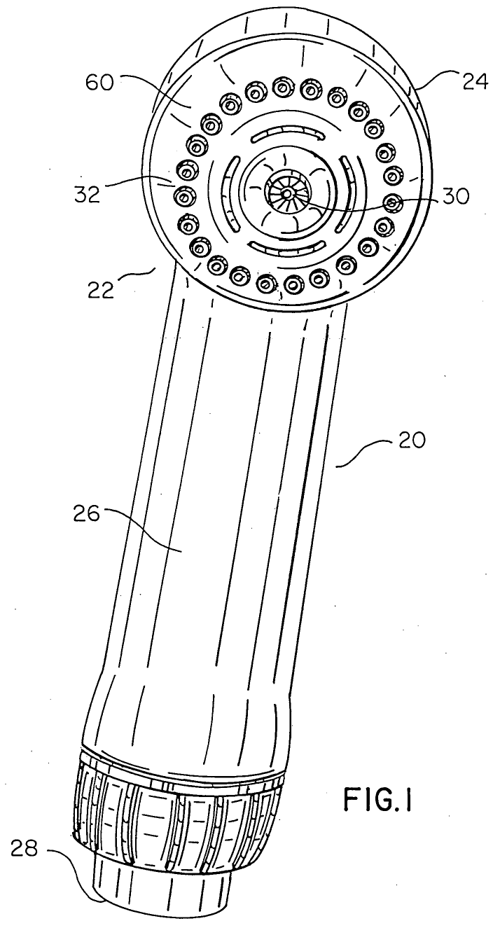

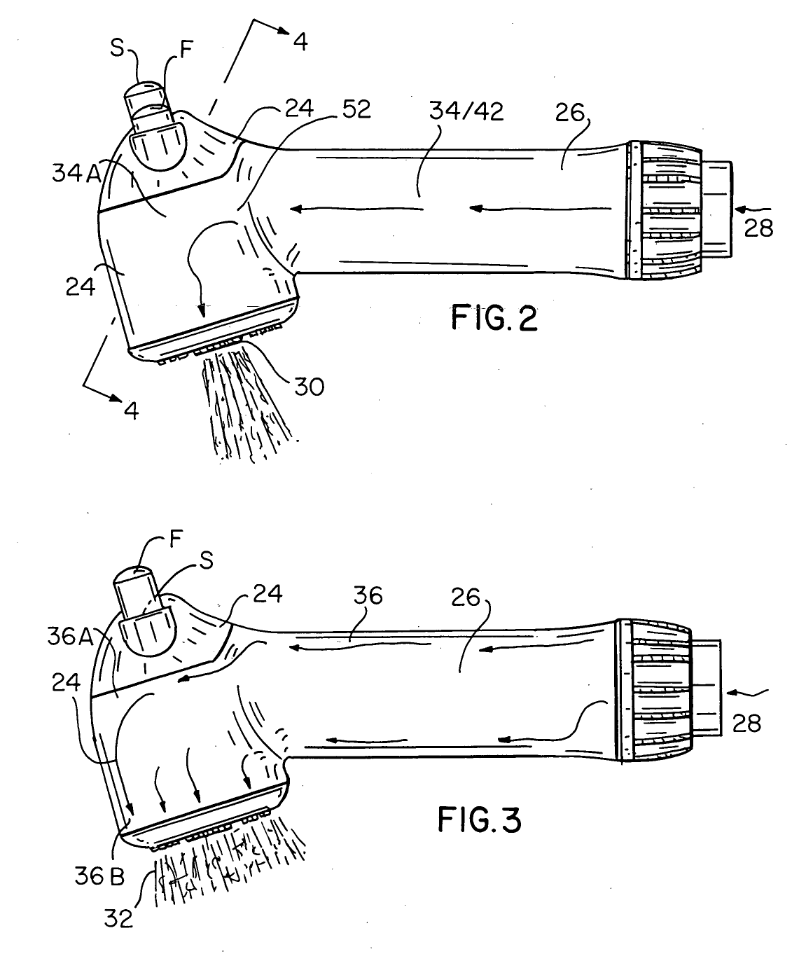

With reference to FIGS. 1 and 2, there is shown the generalized appearance of a multiple flow sink counter-top water sprayer and filtration system 20.

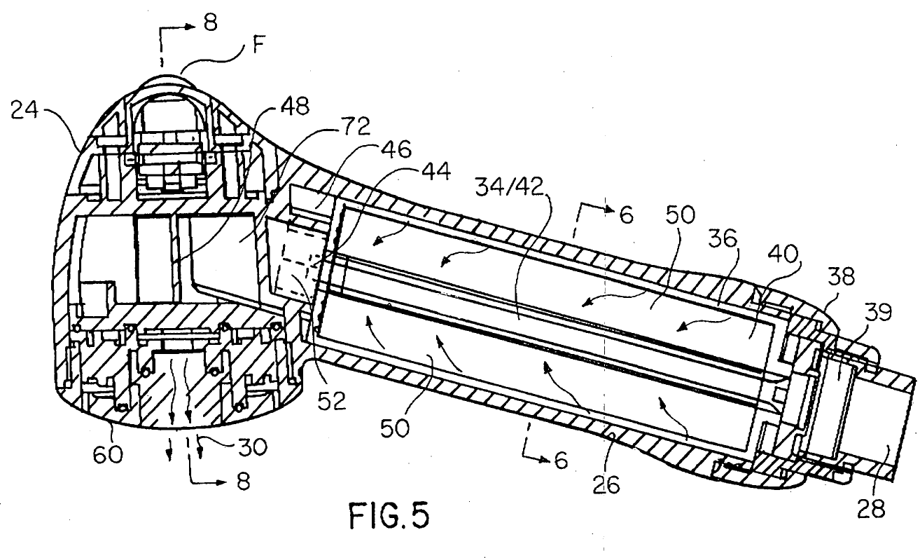

As may be noted, there is provided a substantially longitudinal housing 22 having a downstream portion or dispensing head 24 and an upstream substantially cylindrical portion 26 which portions, collectively, define channels for the flow of water from an inlet 28 to said downstream portion 24. Within downstream portion or head 24 of the system is included stream outlet 30 for the discharging of flows of water from an interior longitudinal channel 34 (see FIGS. 2 and 5) to an ultimate filtered output at said outlet 30 or, alternatively, a discharge of a circumferential spray from outlet 32 through a plurality of apertures. The latter path of flow, which does not provide for purification, is conceptually shown in FIG. 3. As may be noted in FIGS. 2 and 3, actuation of the filtered flow mode of operation is accomplished by depression of button F at the top of head 24, typically by the thumb of the user, while actuation of the unfiltered or spray mode is accomplished by actuation of the button S of head 24.

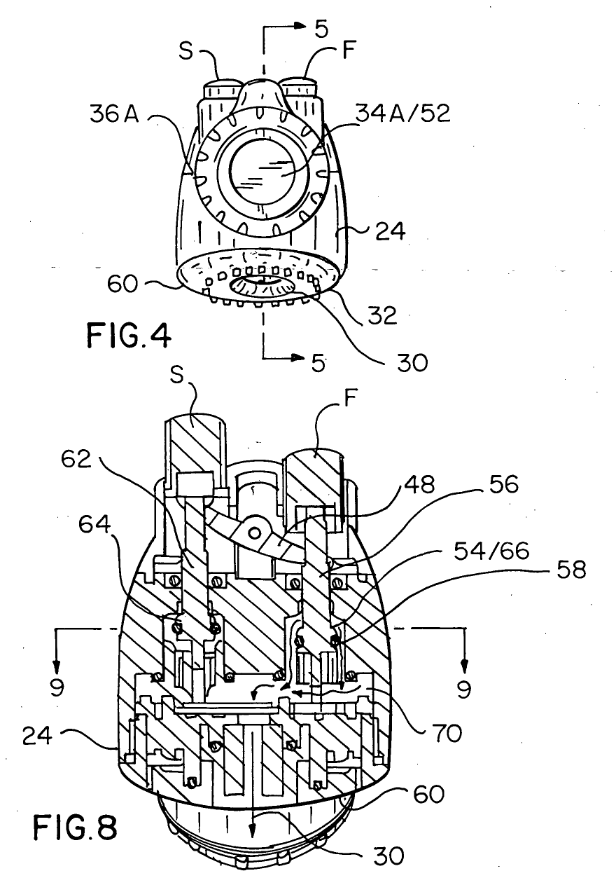

In FIG. 4 is shown a cross-sectional breakaway of the dispensing assembly through Line 4-4 of FIG. 2. Therein may be seen a part of a downstream internal path of flow 34A, as it relates to filtered spray operation shown in FIG. 2, and the internal paths 36A and 36B of flow by which said circumferential path 36 associates with said spray outlet 32 of said circumferential apertures of the spray head.

In the longitudinal cross-sectional view of FIG. 5 may be seen elements of all portions of the present invention, this including said downstream portion 24, said upstream portion 26, said inlet 28, said filtered output stream 30, and said filter mode actuation button F.

More particularly, in FIGS. 5 and 7 is shown the manner in which the supply of water at downstream inlet 28 is circumferentially dispersed through slots 38 of a notched base 39 of an annular substantially cylindrical water filter cartridge 40 which includes an appropriate medium therein and an axial bore 42 through which said path of flow 34 may pass. Said medium may include, but is not limited to, a carbon block, copper, far infrared media, KDF, activated titanium carbon (“ATC”), GAC, ion exchange resin and carbon mixed with silver zeolite, to inhibit bacterial growth within the filter. Thereby, contaminants in water, such as lead and other heavy metals are removed or reduced as the contaminants are bonded to the media. Thereby, organisms specifically controlled include fungi, algae, and bacteria.

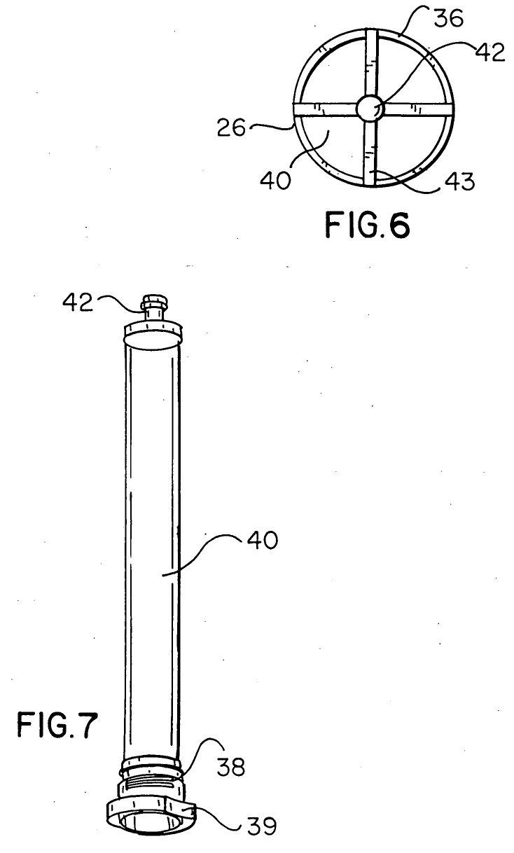

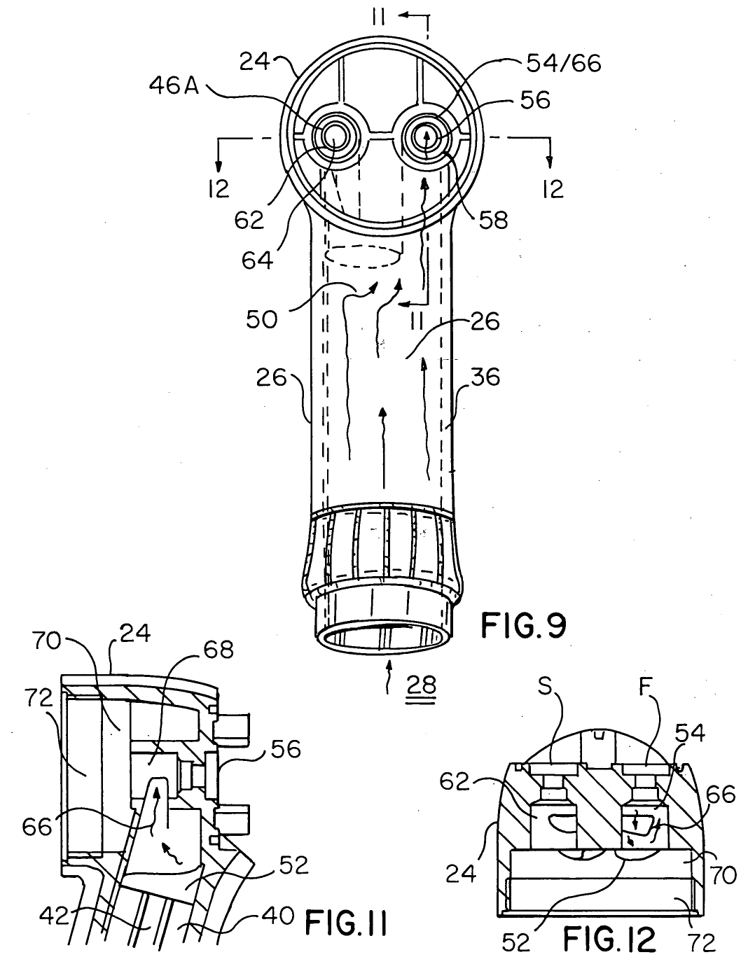

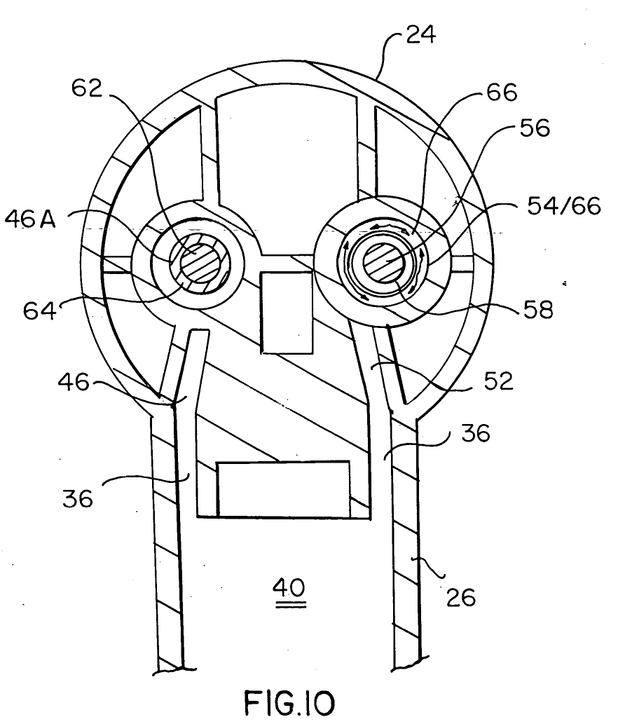

Cartridge 40 is preferably positioned in upstream or handle portion 26 through the use of radial ribs 43 (see FIG. 6) to stabilize the cartridge 40 within the central cavity of the handle portion and, importantly, to define an annular fluid path 36 shown in FIGS. 3 and 5 within handle or downstream portion 26. As may be further noted in FIG. 5, the geometry and integrity of said circumferential/annular path of flow 36 is further assured by pin 44 at a distal end of cartridge 40. It may in said figure, be further noted that through blockage of downstream annular cavity 46, the annular path of flow 36 may be stopped. This is accomplished actuation of button F and thru toggle switch 48 (see FIGS. 5 and 8). When this occurs, tap water from inlet 28 and in annular path 36 is forced radially and spirally through filter 40 along pathways 50, shown in FIGS. 5 and 9. Thereby, by blocking annular fluid flow at downstream cavity 46, tap water is forced radially inwardly and through filter cartridge 40, thereby producing a filtered path of flow 34 into the axial bore 42 of said cartridge 40. This filtered path of flow will exit at region 52 and will communicate with region 34A (see FIGS. 3, 4 and 10). This is accomplished by the above noted actuation of toggle switch 48 (see FIG. 8) which is rotated downward responsive to thumb actuation of filter button F of the sprayer handle. From region 52, filtered water will, through internal galleries 66 reach inlet filter poppet plenum 54 of filter poppet valve 56. (See FIGS. 9-10). Therefrom filtered water 34A flows from inlet plenum 54, past poppet valve ring seal 58 and a valve seat 59, through a series of galleries, and finally is ejected out through central aperture 30 in spray filter face 60. (See FIGS. 5 and 8).

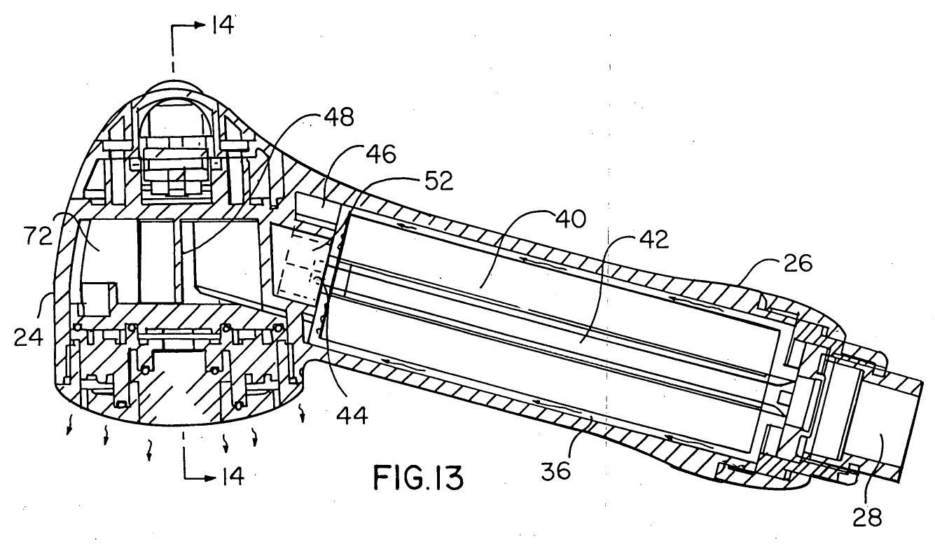

This is more fully shown in the views of FIGS. 9-12. That is, in FIG. 9 is shown a radial cutaway view taken through Line 9-9 of FIG. 8, i.e., thru spray poppet valve 62, spray O-ring 64, filter valve seat 54 and filter poppet valve 56. FIG. 10 is an enlarged view of the upper portion of FIG. 9. As may be noted in FIGS. 9 and 11, filtered water 50 will migrate from region 52 of FIG. 5, 10 and 11 to a region 66 of FIGS. 9, 10 and 11, and therefrom to a cylindrical region 68 of FIG. 11 between respective poppet valves 58 and 62 (see FIG. 9), and therefrom will continue to regions 70 and 72 to path 34A (see FIGS. 2, 4, 5 and 8), and therefrom to stream outlet 30 of face 60 of the spray head 24.

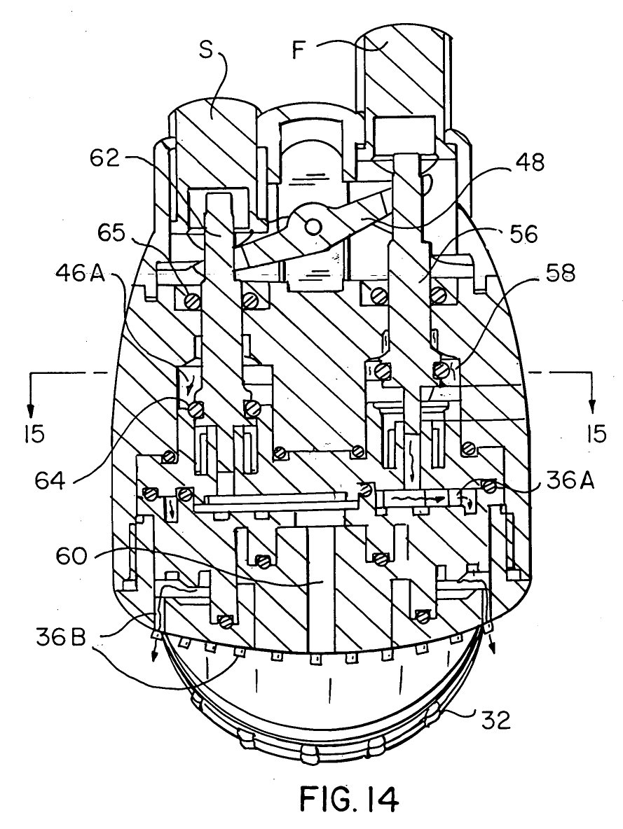

With reference to FIGS. 13 and 14, the inventive system is shown in similar cross-section to that of FIG. 5 and FIG. 8 respectively. However, in the non-filtered, spray mode shown therein, toggle switch 48 blocks downstream bore outlet 52 of axial bore 42 of cartridge 40. Thereby, all water 36 from upstream inlet 28 will pass circumferentially outside of cartridge 40 but within interior walls of handle portion 26, as is noted by flow path 36 in FIGS. 3 and 13. Resultingly, said annular pathway will pass through channels 36A (see FIG. 4) and therefrom will ultimately exit filter face 60 through apertures 32. In FIG. 14, toggle swithch 14 is rotated downward to its spray mode, the effect of which (as above noted) is to block annular outlet region 52 of cartridge bore 42 thereby forcing unfiltered water downstream through fluid paths 36/36A/46/46A/36B.

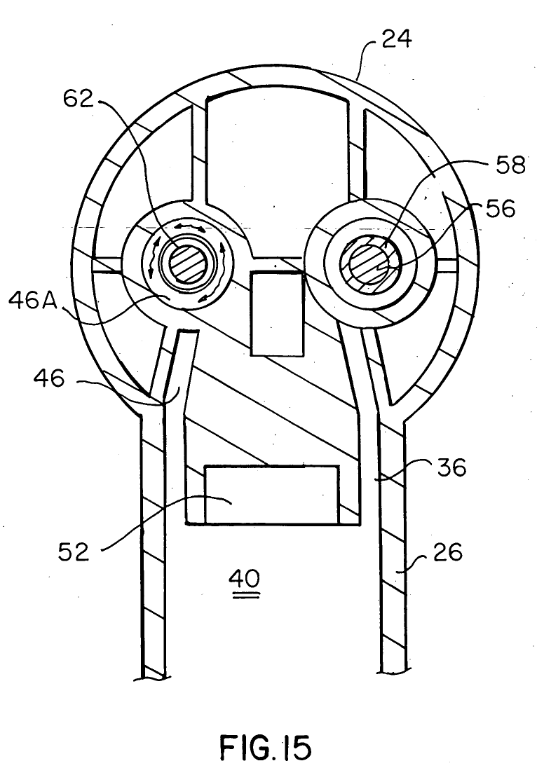

Note the radial cross-section in FIG. 15 is taken at a different plane than the radial cross-section in FIG. 9, namely, thru filter O-ring 58. Therein, unfiltered path of flow 46A may be seen about poppet valve 62 and O-ring 64. Therefrom, the path proceeds to channels 36A (see FIG. 4) and spray outlets 36B (see FIG. 14) of face 60 of head 24.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the claims appended herewith.

1. A multiple flow counter-top water sprayer and filter system having a selectably by-passable filter cartridge, the system comprising:
(a) a housing having an upstream portion and a downstream portion and defining, through said portions, channels for the flow of water;
(b) an inlet to said upstream portion for admitting a flow of water into said channels;
(c) outlets in said downstream portion of said housing for discharging respective filtered and unfiltered flows of water from respective channels;
(d) an annular water-purifying cartridge having a tubular shell including concentric interior and exterior walls to contain a filter material, said cartridge including an axial bore running lengthwise of said cartridge and said exterior wall of said cartridge secured within said upstream portion at a radial offset from an interior surface of said upstream portion of said housing to establish an annular path of flow which by-passes said cartridge;
(e) means for selectably blocking an outlet of said annular path of flow about said cartridge, wherein water within said path is confined therein forcing said path of water radially through said cartridge, into said axial bore thereof, and therefrom through an outlet of said bore into said downstream portion of said housing, and in turn to a stream spout outlet of filtered water of said sprayer; and
(f) means for selectably blocking said axial bore of said cartridge, thereby forcing said flow of water into said annular path of flow external to said cartridge and into fluid communication with a circumferential input to said downstream portion of said housing and to a spray spout outlet of unfiltered water of said sprayer.

2. The system as recited in claim 1, in which said means for selectably blocking comprises a unitary end cap including radial ribs for establishment of said annular offset of said cartridge.

3. The system as recited in claim 1, in which said annular water filter cartridge comprises a carbon block filter.

4. The system as recited in claim 3, in which said block filter includes means for the selectable removal and replacement thereof from said housing.
